(19) United States
(12) Patent Application Publication
(10) Pub. No.: US 2025/0227083 A1
(43) Pub. Date: Jul. 10, 2025

(54) ELECTRONIC DEVICE AND METHOD FOR PROVIDING VIRTUAL SPACE

(71) Applicant: SAMSUNG ELECTRONICS CO., LTD., Suwon-si (KR)

(72) Inventors: Taeyang SONG, Suwon-si (KR); Moonjeong KIM, Suwon-si (KR); Youngrog KIM, Suwon-si (KR); Taeyeong KIM, Suwon-si (KR); Wonkyu SUNG, Suwon-si (KR); Jonghyuck YOO, Suwon-si (KR); Changhan LEE, Suwon-si (KR); Sukdong KIM, Suwon-si (KR); Soohyun SEO, Suwon-si (KR)

(73) Assignee: SAMSUNG ELECTRONICS CO., LTD., Suwon-si (KR)

(21) Appl. No.: 19/094,290

(22) Filed: Mar. 28, 2025

Related U.S. Application Data
(63) Continuation of application No. PCT/KR2023/015274, filed on Oct. 4, 2023.

(30) Foreign Application Priority Data
Nov. 28, 2022 (KR) 10-2022-0162107
Dec. 14, 2022 (KR) 10-2022-0175113

(51) Int. Cl. H04L 51/216; G06F 3/0482; G06F 16/535; G06T 11/60

(52) U.S. Cl. CPC H04L 51/216; G06F 3/0482; G06F 16/535; G06T 11/60

(57) ABSTRACT

An electronic device includes: a display; communication circuitry; a memory storing instructions; a speaker; a microphone; and at least one processor operably coupled with the display, the communication circuitry, the memory, the speaker, and the microphone, where the at least one processor is configured to execute the instructions to: based on an application for communication between at least one user and a user of the electronic device in a virtual space being executed, display the virtual space including a first character corresponding to the user of the electronic device and at least one second character corresponding to the at least one user, in a state in which communication between a plurality of users including the user of the electronic device and the at least one user is being performed through the first character and the at least one second character in the virtual space.

### CROSS-REFERENCE TO RELATED APPLICATION(S)

This application is a continuation of International Application No. PCT/KR2023/015274, filed on Oct. 4, 2023, in the Korean Intellectual Property Receiving Office, which is based on and claims priority to Korean Patent Application No. 10-2022-0162107, filed on Nov. 28, 2022 and Korean Patent Application No. 10-2022-0175113, filed on Dec. 14, 2022, in the Korean Intellectual Property Office, the disclosures of which are incorporated by reference herein in their entireties.

### BACKGROUND

### 1. Field

This disclosure relates to an electronic device and a method for providing a virtual space.

### 2. Description of Related Art

According to development of technology, a virtual space is being used by using a computer or the Internet. Additionally, various software is being developed for providing the virtual space. A user of an electronic device may communicate with another user in real time without time or space constraints by entering the virtual space. The user may perform various activities in the virtual space using a character corresponding to the user.

### SUMMARY

Aspects will be set forth in part in the description which follows and, in part, will be apparent from the description, or may be learned by practice of the presented embodiments.

According to an aspect of the disclosure, an electronic device may include: a display; communication circuitry; a memory storing instructions; a speaker; a microphone; and at least one processor operably coupled with the display, the communication circuitry, the memory, the speaker, and the microphone, where the at least one processor is configured to execute the instructions to: based on an application for communication between at least one user and a user of the electronic device in a virtual space being executed, display the virtual space including a first character corresponding to the user of the electronic device and at least one second character corresponding to the at least one user, in a state in which communication between a plurality of users including the user of the electronic device and the at least one user is being performed through the first character and the at least one second character in the virtual space, obtain log information about the communication between the plurality of users, based on identifying a termination of the communication between the plurality of users in the virtual space, display a plurality of images included in the log information, and based on identifying an input for selecting an image among the plurality of images, display a video included in the log information and corresponding to the selected image.

The at least one processor may be further configured to execute the instructions to: obtain a plurality of videos representing the communication, in the state in which the communication between the plurality of users is being performed, obtain, based on obtaining a plurality of thumbnails of each of the plurality of videos, the plurality of images, and obtain the log information including the plurality of videos and the plurality of images.

The at least one processor may be further configured to execute the instructions to: obtain utterance data of the plurality of users, in the state in which the communication between the plurality of users is being performed, identify, based on the utterance data, a plurality of utterance intervals satisfying a designated condition, and obtain a plurality of videos corresponding to the plurality of utterance intervals.

The at least one processor is further configured to execute the instructions to: obtain, based on gesture data of the first character and the at least one second character and the utterance data of the plurality of users, a plurality of candidate images, obtain, based on filtering the plurality of candidate images, the plurality of images, arrange, based on a time in which the plurality of images are obtained, the plurality of images in a designated frame, and store the plurality of images arranged in the designated frame as the log information.

The at least one processor may be further configured to execute the instructions to: in a state in which the plurality of images are displayed, identify an input for selecting, among the plurality of images, at least one image to be arranged in a designated frame, arrange, based on the input for selecting the at least one image, the at least one image in the designated frame according to a time sequence, and store the at least one image arranged in the designated frame as the log information.

The at least one processor may be further configured to execute the instructions to: store, based on identifying the termination of the communication between the plurality of users in the virtual space, the log information in the memory, display the log information and second log information about a second communication distinct from the communication stored in the memory, and display, based on an input for displaying the log information, the plurality of images.

The at least one processor may be further configured to execute the instructions to: display the first character within a first area of a screen displaying the virtual space, among the first area and a second area in the screen, display the at least one second character within the second area, in a state in which the first character is displayed within the first area, and display a plurality of first text messages based on the communication between the plurality of users superimposed on a portion of the second area.

The at least one processor may be further configured to execute the instructions to: obtain utterance data of the plurality of users, in the state in which the communication between the plurality of users is being performed, obtain, based on setting the utterance data as an input value of a designated model indicated by a plurality of parameters, text data, and obtain, based on the text data, a plurality of second text messages.

The log information may include the plurality of first text messages and the plurality of second text messages.

The at least one processor may be further configured to execute the instructions to: based on identifying the termination of the communication between the plurality of users, arrange the plurality of first text messages and the plurality of second text messages according to the plurality of users, and display, the plurality of first text messages and the plurality of second text messages sorted according to the plurality of users, according to a time sequence.

The at least one processor may be further configured to execute the instructions to: identify an input for setting a type of data to be stored as the log information, and set, based on the input, the type of the data to be stored as the log information, to one of a text type, an image type, and a video type.

The at least one processor may be further configured to execute the instructions to: display an object for obtaining a video superimposed in the virtual space, in the state in which the communication between the plurality of users is being performed, and based on receiving an input on the object, obtain a video representing a communication between the plurality of users for a timing at which the input is received.

According to an aspect of the disclosure, a method of an electronic device may include: based on an application for communication between at least one user and a user of the electronic device in a virtual space being executed, displaying the virtual space including a first character corresponding to the user of the electronic device and at least one second character corresponding to the at least one user; in a state in which communication between a plurality of users including the user of the electronic device and the at least one user is being performed through the first character and the at least one second character in the virtual space, obtaining log information on the communication between the plurality of users; based on identifying a termination of the communication between the plurality of users in the virtual space, displaying a plurality of images included in the log information; and based on identifying an input for selecting an image among the plurality of images, displaying a video included in the log information and corresponding to the selected image.

The method may further include: obtaining a plurality of videos representing the communication, in the state in which the communication between the plurality of users is being performed; obtaining, based on obtaining a plurality of thumbnails of each of the plurality of videos, the plurality of images; and obtaining the log information including the plurality of videos and the plurality of images.

The method may further include: obtaining utterance data of the plurality of users, in the state in which the communication between the plurality of users is being performed; identifying, based on the utterance data, a plurality of utterance intervals satisfying a designated condition; and obtaining a plurality of videos corresponding to the plurality of utterance intervals.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to various embodiments;

FIG. 2 is a simplified block diagram of an electronic device according to an embodiment;

FIG. 3 illustrates an example of an operation of an electronic device according to an embodiment;

FIG. 4 illustrates a flowchart related to an operation of an electronic device according to an embodiment;

FIG. 5 illustrates an example of an operation of an electronic device according to an embodiment;

FIG. 6 illustrates an example of an operation for obtaining a plurality of images as log information in an electronic device according to an embodiment;

FIG. 7 illustrates an example of an operation of an electronic device according to an embodiment;

FIG. 8 illustrates an example of an operation for obtaining a plurality of videos as log information in an electronic device according to an embodiment;

FIG. 9 illustrates an example of an operation of an electronic device according to an embodiment;

FIG. 10 illustrates an example of an operation for converting an utterance signal into a text message and obtaining as log information in an electronic device according to an embodiment;

FIG. 11A illustrates a flowchart related to an operation of an electronic device according to an embodiment;

FIG. 11B illustrates an example of an operation of an electronic device according to an embodiment;

FIG. 12 illustrates an example of an operation of an electronic device according to an embodiment; and

FIG. 13 illustrates an example of an operation of an electronic device according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

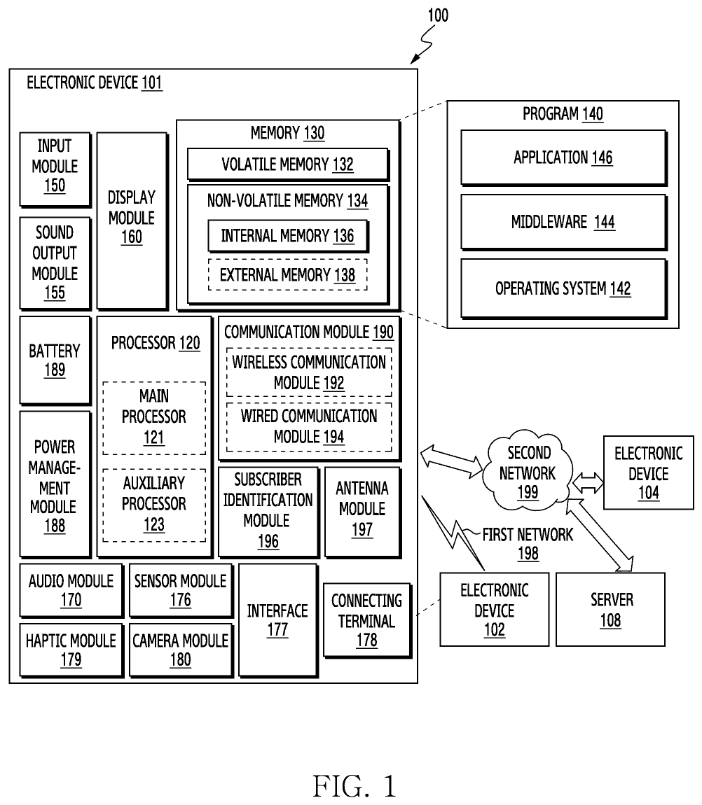

FIG. 1 is a block diagram of an electronic device in a network environment according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, an electronic device (e.g., the electronic device 101 of FIG. 1) may provide a service related to a virtual space to a user by using an application. The user may perform communication with at least one other user by using a character corresponding to the user in the virtual space. While communication between a plurality of users including the user of the electronic device and the at least one other user is performed, log information on the communication between the plurality of users may be obtained. In case that the communication between the plurality of users is terminated, the electronic device may provide a communication log as text, an image and/or a video based on the log information on the communication between the plurality of users. In the following specification, various embodiments of providing the communication log may be described.

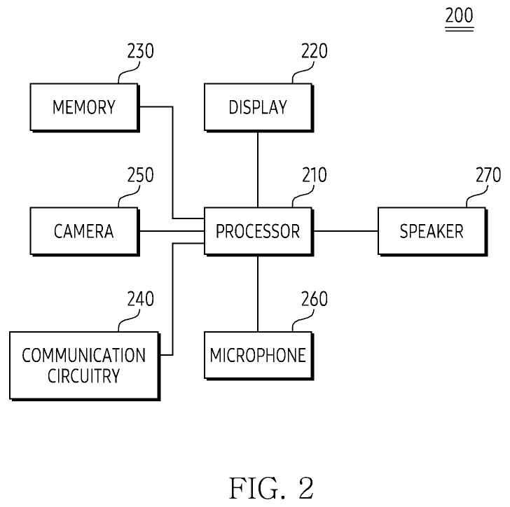

FIG. 2 is a simplified block diagram of an electronic device according to an embodiment.

Referring to FIG. 2, an electronic device 200 may include a portion or all of components of the electronic device 101 illustrated in FIG. 1. For example, the electronic device 200 may correspond to the electronic device 101 of FIG. 1.

According to an embodiment, the electronic device 200 may include a processor 210, a display 220, memory 230, communication circuitry 240, a camera 250, a microphone 260, and/or a speaker 270. According to an embodiment, the electronic device 200 may include at least one of the processor 210, the display 220, the memory 230, the communication circuitry 240, the camera 250, the microphone 260, and the speaker 270. For example, at least a portion of the processor 210, the display 220, the memory 230, the communication circuitry 240, the camera 250, the microphone 260, and the speaker 270 may be omitted according to an embodiment.

According to an embodiment, the electronic device 200 may include the processor 210. The processor 210 may be operatively (or operably) coupled with or connected with the display 220, the memory 230, the communication circuitry 240, the camera 250, the microphone 260, and the speaker 270. The processor 210 being operatively coupled with or connected with the display 220, the memory 230, the communication circuitry 240, the camera 250, the microphone 260, and the speaker 270 may mean that the processor 210 may control the display 220, the memory 230, the communication circuitry 240, the camera 250, the microphone 260, and the speaker 270.

For example, the processor 210 may control the display 220, the memory 230, the communication circuitry 240, the camera 250, the microphone 260, and the speaker 270. The display 220, the memory 230, the communication circuitry 240, the camera 250, the microphone 260, and the speaker 270 may be controlled by the processor 210. For example, the processor 210 may be formed of at least one processor. For example, the processor 210 may include the at least one processor. For example, the processor 210 may correspond to the processor 120 of FIG. 1.

According to an embodiment, the processor 210 may include a hardware component for processing data based on one or more instructions. The hardware component for processing the data may include, for example, an arithmetic and logic unit (ALU), a field programmable gate array (FPGA), and/or a central processing unit (CPU).

According to an embodiment, the electronic device 200 may include the display 220. For example, the display 220 may include a touch panel (or a touch screen) and an integrated circuit (IC). For example, the display 220 may be used to display various screens. The display 220 may be used to display a user interface of an application (e.g., an application to provide a service related to a virtual space, an application to provide a telephone function, or an application for message exchange). For example, the display 220 may correspond to the display module 160 of FIG. 1.

According to an embodiment, the electronic device 200 may include the memory 230. For example, the memory 230 may be used to store one or more programs. The one or more programs may include instructions that cause the electronic device 200 to perform a defined operation, when executed by the processor 210 of the electronic device 200. For example, the memory 230 may correspond to the memory 130 of FIG. 1. For example, the memory 230 may be a volatile memory unit or units. For example, the memory 230 may be a nonvolatile memory unit or units. For example, the memory 230 may be another type of a computer-readable medium, such as a magnetic or optical disk. For example, the memory 230 may store data obtained based on an operation (e.g., an algorithm execution operation) performed in the processor 210.

According to an embodiment, the electronic device 200 may include the communication circuitry 240. For example, the communication circuitry 240 may correspond to at least a portion of the communication module 190 of FIG. 1. For example, the communication circuitry 240 may be used for various radio access technologies (RATs). For example, the communication circuitry 240 may be used to perform cellular communication. For example, the communication circuitry 240 may be used to perform Bluetooth communication, wireless local area network (WLAN) communication, or ultra wideband (UWB) communication.

According to an embodiment, the electronic device 200 may include the camera 250. For example, the camera 250 may be used to obtain an image of a portion (e.g., a face or a hand) of a body of a user of the electronic device 200. The camera 250 may be arranged toward the user to obtain the image of the portion of the body of the user. According to an embodiment, the camera 250 may include a plurality of cameras to obtain the image of the portion of the body of the user.

According to an embodiment, the electronic device 200 may include the microphone 260 (e.g., the input module 150 of FIG. 1). The microphone 260 may identify an electrical signal corresponding to vibration of atmosphere. For example, the processor 210 may identify a sound (e.g., a voice of the user) generated from the user by using the microphone 260. The processor 210 may transmit information on the sound generated from the user to an external electronic device.

According to an embodiment, the electronic device 200 may include the speaker 270. For example, the speaker 270 may be used to output (or provide) a sound. The processor 210 may receive information on a sound generated by another user from the external electronic device, and then output sound through the speaker 270 based on the received information. For example, the speaker 270 may correspond to the sound output module 155 of FIG. 1.

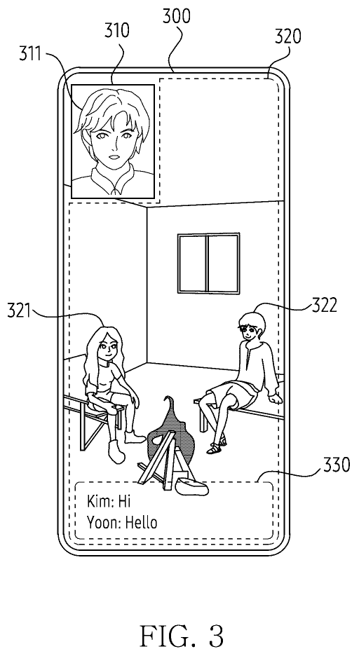

FIG. 3 illustrates an example of an operation of an electronic device according to an embodiment.

Referring to FIG. 3, a processor 210 of an electronic device 200 may display a screen 300 though a display 220.

According to an embodiment, the processor 210 may execute an application for communication with at least one other user distinct from a user of the electronic device 200. The processor 210 may display the screen 300 based on the execution of the application. For example, the screen 300 may display a virtual space. In an embodiment, the processor 210 may display a character 311 corresponding to the user of the electronic device 200 or characters 321 and 322 corresponding to other users (or external users) of external electronic devices in the virtual space. For example, the screen 300 may include a first area 310 and a second area 320. For example, the processor 210 may display the character 311 corresponding to the user of the electronic device 200 on the first area 310. For example, the processor 210 may display the characters 321 and 322 corresponding to the other users (or the external users) of the external electronic devices in the second area 320. The character 321 may correspond to a first external user. The character 322 may correspond to a second external user. According to an embodiment, the processor 210 may display the virtual space from a three-person perspective. For example, the processor 210 may display the character 311 corresponding to the user of the electronic device 200 and the characters 321 and 322 corresponding to the other users together within the second area 320, in a screen for displaying the virtual space. For example, the processor 210 may display the screen (e.g., the screen 320) representing the virtual space based on one of a first-person perspective and the three-person perspective. The processor 210 may display the screen representing the virtual space according to one of the first-person perspective and the three-person perspective based on an input for changing a perspective.

For example, the processor 210 may obtain information on the user of the electronic device 200 by using the camera 250 and/or the microphone 260. For example, the processor 210 may obtain facial expression data of the user by using the camera 250. The processor 210 may change a facial expression of the character 311 corresponding to the user based on the facial expression data of the user. For example, the processor 210 may obtain utterance data of the user by using the microphone 260. The processor 210 may output a voice signal through the character 311 corresponding to the user based on the utterance data of the user.

According to an embodiment, the processor 210 may set a third area 330 in a portion of the second area 320. For example, the processor 210 may display a text message related to communication between a plurality of users in the third area 330. For example, in case that the electronic device 200 (or the external electronic device) does not include the microphone 260, the user of the electronic device 200 may communicate with the at least one other user by using the text message. The processor 210 may display the text message obtained from the user in the third area 330. According to an embodiment, the third area 330 may be set in association with the characters 311, 321, and 322. In an embodiment, the processor 210 may display a speech bubble in association with the characters 311, 321, and 322 within the second area 320. The processor 210 may display the text message obtained from the plurality of users in the speech bubble.

In case that communication between the plurality of users in the virtual space is terminated, the user of the electronic device 200 may not check log information on the communication in the virtual space. Accordingly, the processor 210 of the electronic device 200 may obtain and provide the log information on the communication between the plurality of users in the virtual space. In the following specification, an operation for obtaining the log information on the communication between the plurality of users in the virtual space and providing the log information stored in various content types may be described.

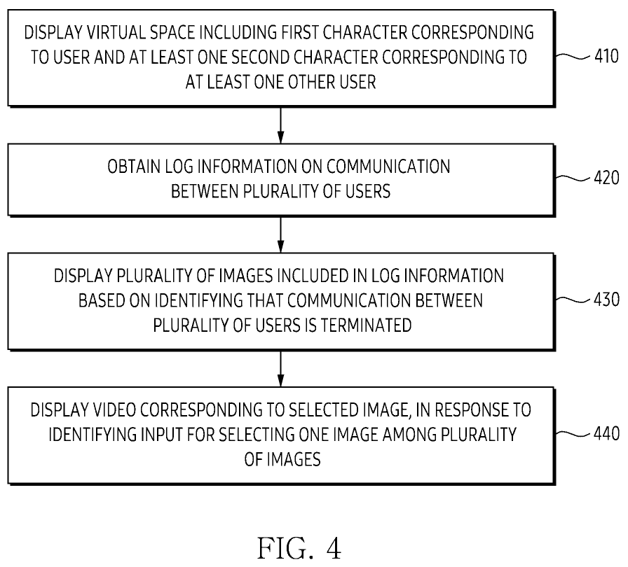

FIG. 4 illustrates a flowchart related to an operation of an electronic device according to an embodiment.

Referring to FIG. 4, in an operation 410, a processor 210 may display a virtual space including a first character corresponding to a user and at least one second character corresponding to at least one other user. For example, the processor 210 may display the virtual space including the first character corresponding to the user and the at least one second character corresponding to the at least one other user, while executing an application for communication with the at least one other user distinct from the user of an electronic device 200 in the virtual space.

According to an embodiment, the processor 210 may execute the application for the communication with the at least one other user distinct from the user of the electronic device 200. For example, the application may be used to communicate with the at least one other user through a character representing the user in the virtual space.

For example, the processor 210 may display a user interface related to the application based on execution of the application. The user interface related to the application may include the virtual space including the first character corresponding to the user and the at least one second character corresponding to the at least one other user.

For example, the processor 210 may display the first character (e.g., the character 311 of FIG. 3) within a first area among the first area (e.g., the area 310 of FIG. 3) and a second area (e.g., the area 320 of FIG. 3) within the screen displaying the virtual space. The processor 210 may display the at least one second character (e.g., the characters 321 and 322 of FIG. 3) within the second area among the first area and the second area within the screen displaying the virtual space. As an example, the first character may correspond to the user of the electronic device 200. Each of the at least one second character may correspond to the at least one other user. The processor 210 may display a plurality of first text messages related to communication between a plurality of users in a portion of the second area. For example, the processor 210 may display the first text messages related to the communication between the plurality of users within a third area set in the portion of the second area.

In an operation 420, the processor 210 may obtain log information on the communication between the plurality of users. For example, the processor 210 may obtain the log information on the communication between the plurality of users, while the communication between the plurality of users including the user and the at least one other user is performed, through the first character and the at least one second character. For example, the log information may include conversational content between the plurality of users, videos related to a motion of the first character and the at least one second character, and/or images including the first character and the at least one second character. As an example, the conversational content between the plurality of users may include audio and/or text.

For example, the processor 210 may obtain a video for the communication between the plurality of users through the first character and the at least one second character in the virtual space. The processor 210 may store the obtained video as the log information.

For example, the processor 210 may store text data of chat content between the plurality of users through the first character and the at least one second character as the log information in the virtual space.

For example, the processor 210 may obtain voice data for the communication between the plurality of users in the virtual space. The processor 210 may store the obtained voice data as the log information. As an example, the processor 210 may convert the voice data into the text data. The processor 210 may store the converted text data as the log information.

For example, the processor 210 may obtain an image for the communication between the plurality of users through the first character and the at least one second character in the virtual space. The processor 210 may store the image as the log information.

According to an embodiment, the processor 210 may set a type of data to be obtained as the log information to one of a video type, an image type, and a text type. For example, the processor 210 may obtain data on one of the video type, the image type, and the text type. According to an embodiment, the processor 210 may obtain all data of the video type, the image type, and the text type.

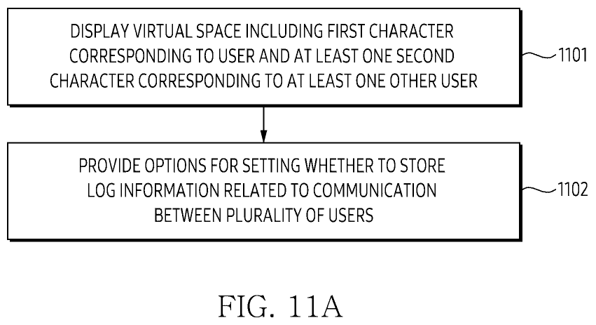

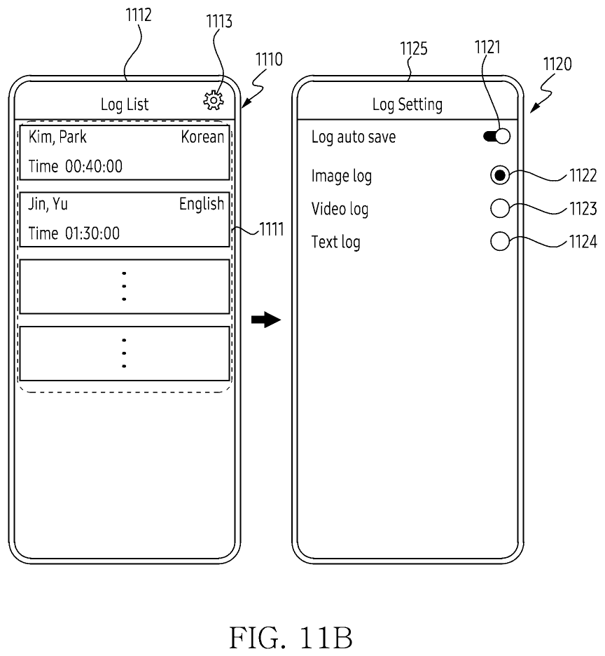

For example, the processor 210 may identify an input for setting the type of the data to be stored as the log information. The processor 210 may set the type of the data to be stored as the log information to one of the text type, the image type, and the video type based on the identified input. According to an embodiment, the processor 210 may identify the input for setting the type of the data to be stored as the log information, before the communication between the plurality of users is performed in the virtual space. According to an embodiment, the processor 210 may identify the input for setting the type of the data to be stored as the log information after the communication between the plurality of users is terminated in the virtual space. According to an embodiment, the processor 210 may identify the input for setting the type of the data to be stored as the log information, while the communication between the plurality of users is performed in the virtual space. An example in which the processor 210 identifies the input for setting the type of the data to be stored as the log information will be described in FIGS. 11A and 11B.

According to an embodiment, the processor 210 may obtain a plurality of videos representing the communication, while the communication between the plurality of users is performed. The processor 210 may obtain a plurality of images based on obtaining a plurality of thumbnails of each of the plurality of videos. The processor 210 may obtain the log information including the plurality of videos and the plurality of images.

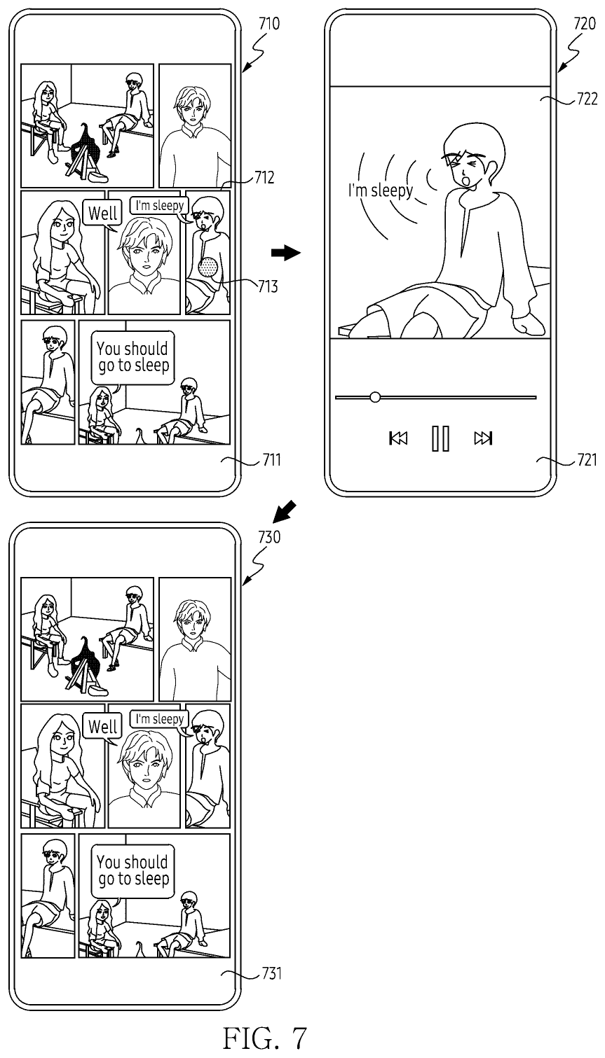

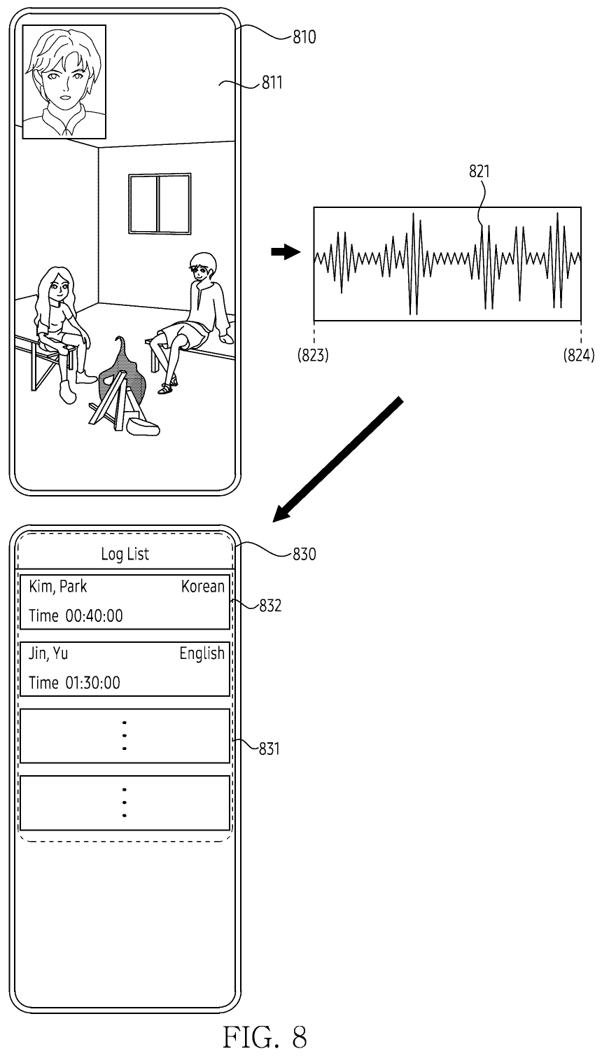

For example, the processor 210 may obtain utterance data related to the plurality of users, while the communication between the plurality of users is performed. In an embodiment, the processor 210 may identify a plurality of utterance intervals satisfying a designated condition, based on the utterance data. As an example, the processor 210 may identify the plurality of utterance intervals maintained for a designated time interval, in a state in which magnitude of an utterance signal included in the utterance data is greater than or equal to designated magnitude. The processor 210 may obtain the plurality of videos corresponding to the plurality of utterance intervals. The processor 210 may obtain the plurality of images based on obtaining the plurality of thumbnails of each of the plurality of videos. The processor 210 may obtain the plurality of videos and the plurality of images as the log information. For example, an example in which the processor 210 obtains the log information including the plurality of videos and the plurality of images will be described in FIGS. 7 and 8.

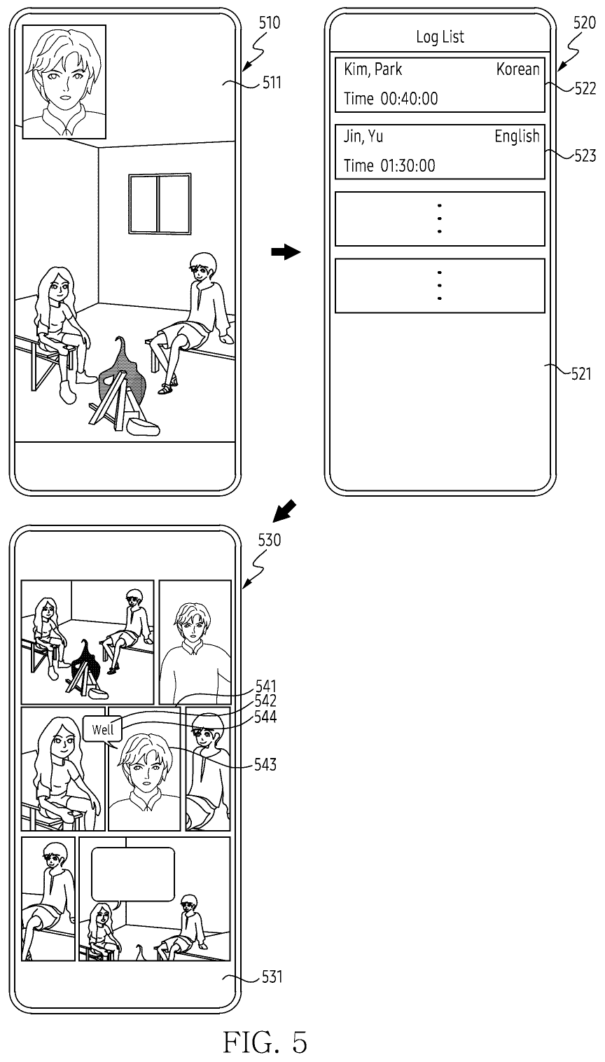

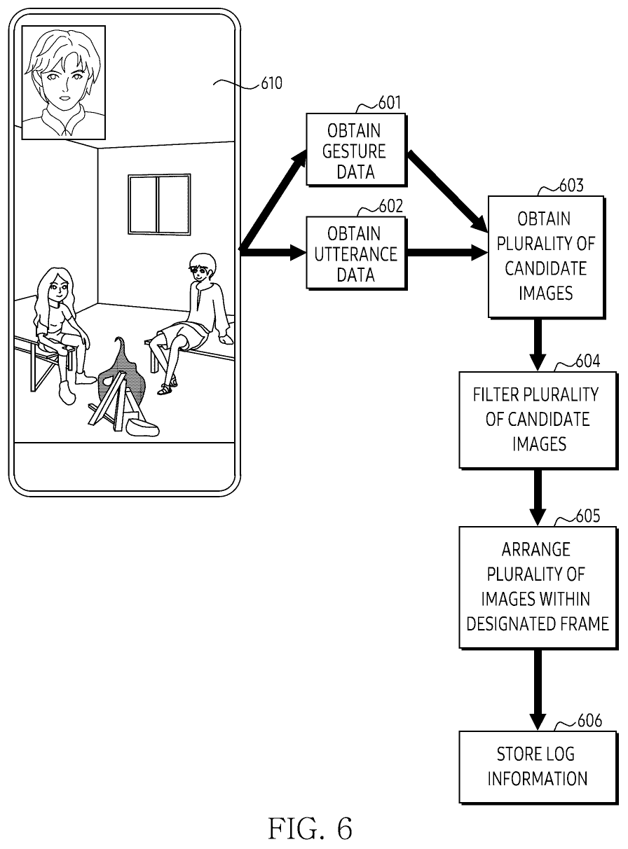

According to an embodiment, the processor 210 may obtain gesture data related to the first character and the at least one second character, and the utterance data related to the plurality of users, while the communication between the plurality of users is performed. In an embodiment, the processor 210 may obtain a plurality of candidate images based on the gesture data related to the first character and the at least one second character, and the utterance data related to the plurality of users. For example, the processor 210 may obtain the plurality of images based on filtering the plurality of candidate images. For example, the processor 210 may arrange the plurality of images within a designated frame based on a time in which the plurality of images was obtained. The processor 210 may store the plurality of images arranged within the designated frame as the log information. For example, an example in which the processor 210 stores the log information including the plurality of images arranged within the designated frame will be described in FIGS. 5 and 6.

According to an embodiment, the processor 210 may display a plurality of first text messages related to communication between the plurality of users in the portion of the second area in which the at least one second character is displayed. For example, the plurality of first text messages may mean text messages inputted from the plurality of users.

The processor 210 may obtain the utterance data related to the plurality of users while the communication between the plurality of users is performed. The processor 210 may obtain the text data, based on setting the utterance data as an input value of a designated model indicated by a plurality of parameters. The processor 210 may obtain a plurality of second text messages based on the text data.

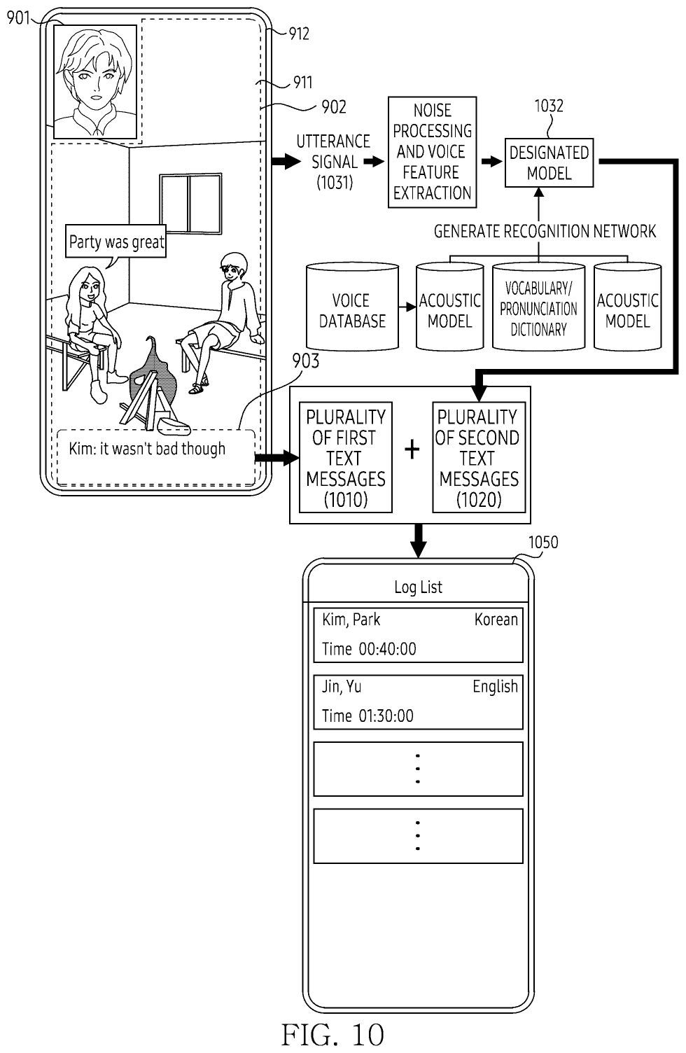

The processor 210 may obtain the log information including the plurality of first text messages and the plurality of second text messages. An example in which the processor 210 obtains the log information including the plurality of first text messages and the plurality of second text messages will be described with reference to FIG. 10.

In an operation 430, the processor 210 may display the plurality of images included in the log information based on identifying that communication between the plurality of users is terminated. For example, the processor 210 may identify the time in which the plurality of images was obtained. The processor 210 may arrange the plurality of images within the designated frame based on the time in which the plurality of images was obtained. The processor 210 may display the plurality of images arranged within the designated frame. For example, the processor 210 may display the plurality of images implemented in a cartoon format. The processor 210 may display the plurality of images implemented in the cartoon format according to a time sequence.

In an operation 440, in response to identifying an input for selecting one image among the plurality of images, the processor 210 may display a video corresponding to the selected image. For example, the processor 210 may display the video included in the log information and corresponding to the selected image, in response to identifying the input for selecting one image of the plurality of images.

The processor 210 may identify the input for selecting one image among the plurality of images. For example, the processor 210 may identify the input for selecting one image among the plurality of images implemented in the cartoon format according to the time sequence. The processor 210 may display a video corresponding to one image. For example, the selected image may be a thumbnail of the video. The processor 210 may play and display the video corresponding to the selected image among the plurality of stored videos.

For example, the selected image may be an intermediate frame of the video. The processor 210 may play a video from before a unit time interval to after the unit time interval, from a frame corresponding to the selected image.

FIG. 5 illustrates an example of an operation of an electronic device according to an embodiment.

Referring to FIG. 5, in a state 510, a processor 210 of an electronic device 200 may display a virtual space 511 including a first character corresponding to a user and at least one second character corresponding to at least one other user, while an application for communication with the at least one other user distinct from the user of the electronic device 200 is executed. For example, a screen displayed in the state 510 may correspond to the screen 300 displayed in FIG. 3. For example, the first character and the second character displayed in the virtual space 511 of the state 510 may be understood substantially the same as characters 321 and 322 included in the screen 300 of FIG. 3.

According to an embodiment, the processor 210 may obtain log information on communication between a plurality of users, while the communication between the plurality of users is performed. For example, the processor 210 may obtain a plurality of videos representing the communication.

For example, the processor 210 may obtain utterance data related to the plurality of users while the communication between the plurality of users is performed. The processor 210 may identify a plurality of utterance intervals satisfying a designated condition, based on the utterance data. The processor 210 may obtain a plurality of videos corresponding to the plurality of utterance intervals. For example, the processor 210 may identify that the utterance data satisfies the designated condition, based on identifying that magnitude of an utterance signal is maintained for a designated time interval in a state greater than or equal to designated magnitude (e.g., a designated decibel (dB)), based on the utterance data. The processor 210 may identify the plurality of utterance intervals maintained for the designated time interval in the state in which the magnitude of the utterance signal is greater than or equal to the designated magnitude. The processor 210 may obtain the plurality of videos corresponding to the plurality of utterance intervals.

For example, the processor 210 may display an object (e.g., a recording button) for obtaining a video, while the communication between the plurality of users is performed. The processor 210 may monitor an utterance of the plurality of users. The processor 210 may identify whether the utterance data obtained according to monitoring satisfies a designated condition, based on the monitoring the utterance of the plurality of users. In an embodiment, the processor 210 may display the object (e.g., the recording button) for obtaining the video, in response to identifying that the obtained utterance data satisfies the designated condition. For example, the processor 210 may obtain the video representing the communication between the plurality of users from a timing in which an input is received, in response to the input on the object.

As an example, the processor 210 may identify utterance content based on the utterance data obtained according to the monitoring. The processor 210 may identify that the utterance data satisfies the designated condition, based on identifying the utterance content. As an example, the processor 210 may identify that the utterance data obtained according to the monitoring satisfies the designated condition, based on identifying that the magnitude of the utterance signal is maintained for the designated time interval in the state greater than or equal to the designated magnitude (e.g., the designated decibel (dB)), based on the utterance data obtained according to the monitoring.

According to an embodiment, the processor 210 may identify that the communication between the plurality of users is terminated. For example, the processor 210 may change a state of the electronic device 200 from the state 510 to a state 520 based on identifying that the communication between the plurality of users is terminated.

According to an embodiment, in the state 520, the processor 210 may store the log information in memory 230, based on identifying that the communication between the plurality of users is terminated, in a virtual space. In an embodiment, the processor 210 may display a log list stored in the memory 230 on the screen 521. For example, the processor 210 may display the log information and other log information related to other communication distinct from the communication between the plurality of users, stored in the memory 230, through the log list. For example, the processor 210 may display an object 522 representing the log information and an object 523 representing the other log information. For example, the object 522 may include information on a name (e.g., Kim and Park) of the at least one other user. For example, the object 522 may include information on a time (e.g., 40 minutes) in which the communication with the at least one other user is performed. For example, the object 522 may include information on a language type (e.g., Korean) in which the communication is performed with the at least one other user. For example, the processor 210 may store the log list according to a time sequence. For example, the object 523 may be implemented substantially the same as the object 522.

According to an embodiment, the processor 210 may identify an input for displaying log information among the log information and the other log information, displayed through the log list. For example, the processor 210 may identify an input on the object 522. The processor 210 may change the state of the electronic device 200 from the state 520 to a state 530 based on identifying the input for displaying the log information.

According to an embodiment, in the state 530, the processor 210 may display a plurality of images on a screen 531 based on identifying the input on the object 522 which is the input for displaying the log information. For example, the processor 210 may identify a plurality of videos corresponding to the plurality of images. The processor 210 may identify conversational content based on the plurality of videos. For example, the processor 210 may display at least one text representing the conversational content on at least a portion of the plurality of images.

As an example, the processor 210 may identify a video corresponding to an image 541 among the plurality of images. The processor 210 may identify utterance data of the video. The processor 210 may identify the conversational content based on the utterance data. For example, the processor 210 may display text 542 representing the conversational content in an object 544 representing a speech bubble. The object 544 may be displayed in association with a character 543 corresponding to an utterer. According to an embodiment, the processor 210 may identify the utterer, and identify and display the image 541 including the character 543 corresponding to the utterer.

According to an embodiment, the processor 210 may arrange the plurality of images within a designated frame. The processor 210 may arrange the plurality of images within the designated frame implemented in a cartoon format. The processor 210 may arrange the plurality of images within the designated frame so that the user may check the plurality of images according to a time sequence.

FIG. 6 illustrates an example of an operation for obtaining a plurality of images as log information in an electronic device according to an embodiment.

Referring to FIG. 6, in an operation 601, a processor 210 may obtain gesture data on a first character and at least one second character, while communication between a plurality of users is performed through the first character and the at least one second character in a virtual space 610. For example, a plurality of characters including the first character and the at least one second character may be displayed according to a gesture (e.g., a facial expression or a motion) of the plurality of users. For example, a screen displaying the virtual space 610 may correspond to a screen 300 displayed in FIG. 3. For example, the first character and the second character displayed in the virtual space 610 may be understood substantially the same as characters 321 and 322 included in the screen 300 of FIG. 3.

For example, the first character may identify a gesture of the user of an electronic device 200 by using a camera 250. The processor 210 may display the first character performing a gesture corresponding to the gesture of the user. The processor 210 may obtain the gesture data on the first character and the at least one second character.

In an operation 602, the processor 210 may obtain utterance data related to the plurality of users in the virtual space 610. The processor 210 may identify an utterer based on the utterance data related to the plurality of users. The processor 210 may identify one of the plurality of users as the utterer. For example, the operations 601 and 602 may be performed simultaneously.

In an operation 603, the processor 210 may obtain a plurality of candidate images. The processor 210 may capture a scene in which the plurality of users communicates in the virtual space 610, according to the gesture data of the plurality of characters including the first character and the at least one second character and the utterance data of the plurality of users. The processor 210 may obtain the plurality of candidate images based on capturing various scenes. For example, the processor 210 may obtain a candidate image in which the first character corresponding to the user is close-up, based on identifying that the user of the electronic device 200 is uttering. For example, the processor 210 may obtain a candidate image including the first character and the second character, based on identifying a movement of the first character and the second character of the electronic device 200 together.

For example, the processor 210 may identify a candidate video corresponding to the candidate image. The processor 210 may identify text representing conversational content in the candidate video. The processor 210 may obtain the candidate image by displaying the identified text in association with a character corresponding to the utterer. The processor 210 may obtain the plurality of candidate images in a similar manner.

In an operation 604, the processor 210 may filter the plurality of candidate images. The processor 210 may remove the same or similar candidate images among the plurality of candidate images. For example, the processor 210 may obtain a plurality of images based on removing the same or similar candidate images among the plurality of candidate images.

In an operation 605, the processor 210 may arrange the plurality of images within a designated frame. The processor 210 may arrange the plurality of images within the designated frame implemented in a cartoon format. For example, the processor 210 may arrange the plurality of images within the designated frame so that the user may check the plurality of images according to a time sequence.

In an operation 606, the processor 210 may store log information. The processor 210 may store the log information including the plurality of images in memory 230. For example, the processor 210 may store the plurality of images arranged within the designated frame as the log information according to the time sequence. For example, the processor 210 may implement the plurality of images arranged within the designated frame as one collage image according to the time sequence. The processor 210 may store the one collage image as the log information.

FIG. 7 illustrates an example of an operation of an electronic device according to an embodiment.

Referring to FIG. 7, in a state 710, a processor 210 may display a plurality of images on a screen 711. For example, the processor 210 may display the plurality of images arranged within a designated frame on the screen 711 according to a time sequence.

According to an embodiment, the processor 210 may identify an input 713 for selecting an image 712 among the plurality of images. The processor 210 may change a state of an electronic device 200 from the state 710 to a state 720 in response to the input 713 for selecting the image 712 among the plurality of images.

In the state 720, the processor 210 may identify a video 722 corresponding to the image 712 in response to the input 713 for the image 712 among the plurality of images. The processor 210 may execute an application for playing a video based on identifying the video 722. The processor 210 may play the video 722 corresponding to the image 712 in a screen 721 through the application for playing the video.

For example, the image 712 may be an intermediate frame of the video. The processor 210 may play the video 722 from before a unit time interval (e.g., N seconds) to after a unit time interval, from a frame corresponding to the selected image.

For example, the image 712 may be a thumbnail of the video 722. The processor 210 may play the video 722 corresponding to the image 712. The processor 210 may play the video 722 corresponding to the image 712 for a designated time interval.

For example, the processor 210 may identify conversational content related to the image 712. The processor 210 may play the video 722 from a timing in which the conversational content related to the image 712 starts to a timing in which the conversational content is terminated.

According to an embodiment, after the playing of the video 722 is terminated, the processor 210 may change the state of the electronic device 200 from the state 720 to a state 730. The processor 210 may change the state of the electronic device 200 from the state 720 to the state 730 in response to the termination of the playing of the video 722.

In the state 730, the processor 210 may display the plurality of images within a screen 731 in response to the termination of the playing of the video 722. The screen 731 may be substantially the same as the screen 711.

According to an embodiment, the processor 210 may identify the input 713 on the image 712 and play the video 722 corresponding to the image 712, among the plurality of images. The processor 210 may display the plurality of images again in response to identifying that the video 722 is terminated.

FIG. 8 illustrates an example of an operation for obtaining a plurality of videos as log information in an electronic device according to an embodiment.

Referring to FIG. 8, a processor 210 may identify an utterance of a plurality of users, while communication between the plurality of users is performed through a first character and at least one second character in a virtual space 811. The processor 210 may identify that the utterance starts, while communication between the plurality of users is performed in the virtual space 811. The processor 210 may identify an utterer, which is one of the plurality of users, based on the start of the utterance.

For example, the processor 210 may record a screen 810 displaying the virtual space 811 from a timing 823 in which the utterance starts, in response to identifying that the utterance starts. The processor 210 may record the utterance from the timing 823 in which the utterance starts, in response to identifying that the utterance of the utterer stars.

For example, the processor 210 may obtain an utterance signal 821 based on identifying that the utterance stars. The processor 210 may identify the utterance signal 821 from the timing 823 in which the utterance of the utterer starts to a timing 824 in which the utterance of the utterer terminated, based on the identification that the utterance starts. The processor 210 may identify whether magnitude of the utterance signal is maintained for a designated time interval in a state greater than or equal to designated magnitude (e.g., a designated decibel (dB)). For example, the processor 210 may identify from the timing 823 to the timing 824 as the utterance interval, based on identifying that the magnitude of the utterance signal is maintained for the designated time interval in the state greater than or equal to the designated magnitude.

According to an embodiment, the processor 210 may identify a plurality of utterance intervals, according to the above-described operation. The processor 210 may obtain a plurality of videos corresponding to a plurality of utterance intervals. The processor 210 may obtain log information including the plurality of videos and then store the obtained the log information in memory 230.

According to an embodiment, the processor 210 may identify that the communication between the plurality of users terminates in the virtual space 811. The processor 210 may display a log list 831 based on identifying that the communication between a plurality of users terminates in the virtual space 811.

For example, the processor 210 may display the log list 831 in the time sequence. The processor 210 may display the most recently obtained log information at an top end of the log list 831. For example, the processor 210 may display the object 832 representing the most recently obtained log information at the highest top end of the log list 831.

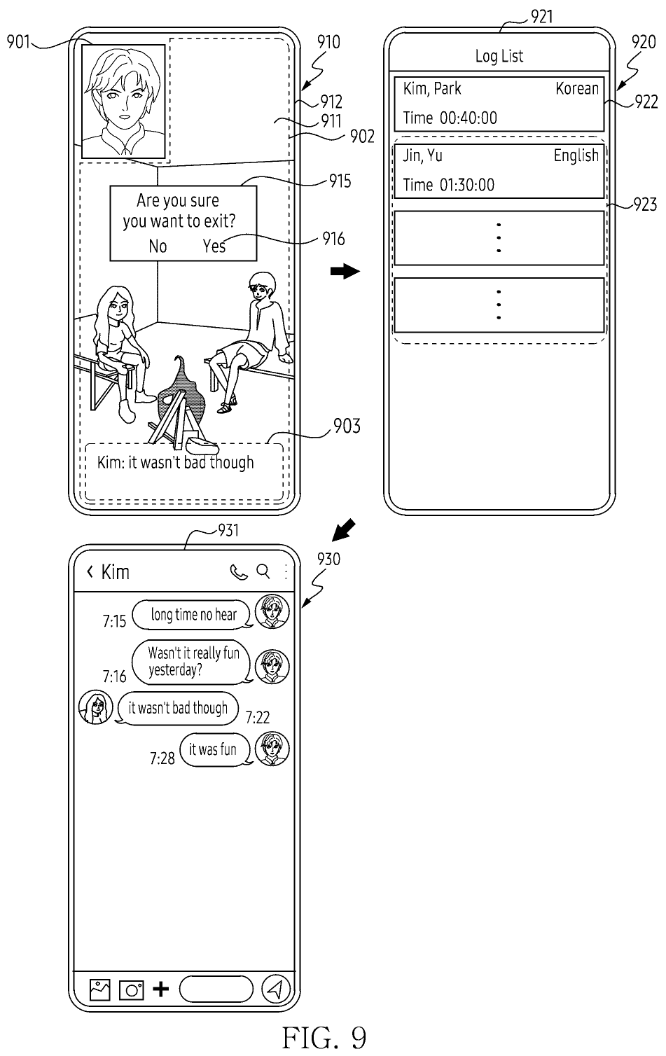

FIG. 9 illustrates an example of an operation of an electronic device according to an embodiment.

Referring to FIG. 9, in a state 910, a processor 210 may display a virtual space 911 in a screen 912. For example, the screen 912 may include a first area 901 and a second area 902. The first area 901 may be used to display a first character corresponding to a user of an electronic device 200. For example, the processor 210 may display the first character corresponding to the user of the electronic device 200 within the first area 901. The second area 902 may be used to display at least one second character corresponding to at least one other user distinct from the user of the electronic device 200. For example, the processor 210 may display the at least one second character within the second area 902, while the first character is displayed in the first area 901. For example, the screen 912 displayed in a state 910 may correspond to the screen 300 displayed in FIG. 3.

According to an embodiment, the processor 210 may display a plurality of first text messages related to communication between a plurality of users, on a portion of the second area 902. For example, the processor 210 may display the plurality of first text messages related to the communication between the plurality of users in the virtual space 911, within a third area 903 set in the portion of the second area 902.

According to an embodiment, the processor 210 may obtain utterance data related to the plurality of users, while the communication between the plurality of users is performed. For example, the processor 210 may obtain utterance signals related to the user of the electronic device 200. The processor 210 may obtain the utterance signals related to the at least one other user. The processor 210 may set utterance data related to the plurality of users as an input value of a designated model indicated by a plurality of parameters. The processor 210 may obtain text data based on setting the utterance data related to the plurality of users as the input value of the designated model indicated by the plurality of parameters. The processor 210 may obtain a plurality of second text messages based on the text data.

For example, the processor 210 may set the utterance data related to the plurality of users as the input value of the designated model based on artificial intelligence. For example, the processor 210 may set the utterance data related to the plurality of users as the input value of the designated model for performing voice recognition. The processor 210 may obtain the text data by converting the utterance data related to the plurality of users into text.

According to an embodiment, the processor 210 may identify an input for exiting the virtual space 911 from the user of the electronic device 200. The processor 210 may display a pop-up window 915 on the screen 912 based on the identified input. For example, the pop-up window 915 may include a message to confirm whether to exit the virtual space 911. The processor 210 may identify that communication between the plurality of users is terminated, based on identifying an input on an object 916 representing confirmation of exiting the virtual space 911. For example, the processor 210 may change a state of the electronic device 200 from the state 910 to a state 920 in response to identifying that the communication between the plurality of users is terminated.

In the state 920, the processor 210 may display a log list in response to identifying that the communication between the plurality of users is terminated. For example, the processor 210 may store log information in memory 230, based on identifying that the communication between the plurality of users is terminated in a virtual space. The processor 210 may display the log list stored in the memory 230 on the screen 921. For example, the processor 210 may display the log information and other log information related to other communication distinct from the communication between the plurality of users, stored in the memory 230, through the log list. For example, the processor 210 may display an object 922 representing the log information and an object 923 representing the other log information. The object 922 may include, for example, information on a name of the at least one other user, information on a time for performing the communication with the at least one other user, and information on a language type for performing the communication with the at least one other user.

For example, the processor 210 may store the log list according to a time sequence. The processor 210 may display the log list according to the time sequence. The processor 210 may display the most recently obtained log information at a top end of the log list. As an example, the log information on the communication between the plurality of users in the virtual space 901 may be displayed as the most recently obtained object 922 at the top end of the log list.

According to an embodiment, the processor 210 may identify an input on the object 922. The processor 210 may change the state of the electronic device 200 from the state 920 to a state 930 in response to the input on the object 922.

According to an embodiment, in the state 930, the processor 210 may sort the plurality of first text messages and the plurality of second text messages according to the plurality of users including the user of the electronic device 200 and the at least one other user. The processor 210 may display the first text messages and the plurality of second text messages sorted according to the plurality of users in the time sequence. The processor 210 may implement and display the first text messages and the plurality of second text messages in a text conversation format. Accordingly, the processor 210 may implement both voice conversation and text conversation between the plurality of users in the virtual space 911 in the form of text conversation according to time and display them on the screen 931.

FIG. 10 illustrates an example of an operation for converting an utterance signal into a text message and obtaining as log information in an electronic device according to an embodiment.

Referring to FIG. 10, in an embodiment, in the processor 210, a screen 912 for displaying a virtual space 911 may include a first area 901, a second area 902, and/or a third area 903. For example, the first area 901 may be used to display a first character corresponding to a user of an electronic device 200. The second area 902 may be used to display at least one second character corresponding to at least one other user. The third area 903 may be used to display a plurality of first text messages related to communication between a plurality of users in a virtual space. For example, the screen 912 may correspond to the screen 300 displayed in FIG. 3.

According to an embodiment, the processor 210 may identify the first text messages representing conversation through text between the plurality of users in the virtual space 911. The processor 210 may store the first text messages in memory 230 (or a buffer of the memory 230). The processor 210 may store the first text messages in the memory 230 in association with a time in which the first text messages are inputted.

According to an embodiment, the processor 210 may obtain utterance data related to the plurality of users, while the communication between the plurality of users is performed. For example, the utterance data may include an utterance signal 1031. The processor 210 may identify the utterance signal 1031 based on an utterance of one the plurality of users. The processor 210 may perform noise processing and voice feature extraction based on the utterance signal 1031. The processor 210 may set a signal on which the noise processing and the voice feature extraction have been performed, as an input value of a designated model 1032. The processor 210 may obtain text data based on setting a signal on which the noise processing and the voice feature extraction have been performed, as the input value of the designated model 1032. The text data may mean data in which the utterance signal 1031 is converted into text. The processor 210 may obtain a plurality of second text messages based on a plurality of utterance signals (e.g., the utterance signal 1031).

For example, the designated model 1032 may be formed based on an acoustic model, a vocabulary/pronunciation dictionary, and/or a language model included in voice database. For example, the memory 230 may include the voice database. For example, the memory 230 may include the voice database including the acoustic model, the vocabulary/pronunciation dictionary, and/or the language model. The processor 210 may form the designated model 1032 based on the acoustic model, the vocabulary/pronunciation dictionary, and/or the language model. For example, the processor 210 may generate a recognition network by using the acoustic model, the vocabulary/pronunciation dictionary, and/or the language model. The processor 210 may form the designated model 1032 based on the recognition network.

According to an embodiment, the processor 210 may store a plurality of first text messages 1010 and/or a plurality of second text messages 1020 as log information in the memory 230. The processor 210 may sort the plurality of first text messages and the plurality of second text messages according to the plurality of users based on identifying that the communication between the plurality of users is terminated. The processor 210 may display the plurality of first text messages and the plurality of second text messages sorted according to the plurality of users in a time sequence.

For example, the processor 210 may display a log list, such as a screen 1050, based on identifying that the communication between the plurality of users is terminated. For example, the screen 1050 may correspond to the screen 921 of FIG. 9.

FIG. 11A illustrates a flowchart related to an operation of an electronic device according to an embodiment.

A method of FIG. 11A may be performed by the electronic device 200 of FIG. 2. For example, a processor 210 may perform operations 1101 and 1102 of FIG. 11A.

Referring to FIG. 11A, in the operation 1101, the processor 210 may display a first character corresponding to a user and at least one second character corresponding to at least one other user in a virtual space. The operation 1101 may correspond to the operation 410 of FIG. 4.

In the operation 1102, the processor 210 may provide options for setting whether to store log information related to communication between a plurality of users. For example, the processor 210 may provide the options for setting whether to store the log information related to the communication between the plurality of users, while the communication is performed between the plurality of users including the user and the at least one other user.

For example, the processor 210 may provide an option for setting the log information related to the communication between the plurality of users to be stored and/or for setting the log information not to be stored. As an example, the processor 210 may store the log information based on an input for selecting the option for setting to store the log information. As an example, the processor 210 may not store the log information based on an input for selecting the option for setting not to store the log information.

According to an embodiment, the processor 210 may provide sub-options for setting a type of the log information to at least one of an image type, a video type, and a text type, based on the input for selecting the option for setting to store the log information. For example, the processor 210 may provide the sub-options for setting a type of data to be obtained as the log information to the at least one of the image type, the video type, and the text type.

For example, the processor 210 may store voice information between the plurality of users, and image information related to the first character and the at least one second character, while communication is being performed, based on a storage type of the log information being set as the image type.

For example, the processor 210 may store the voice information between the plurality of users, and video information related to the first character and the at least one second character, while communication is being performed, based on the storage type of the log information being set as the video type.

For example, the processor 210 may convert the voice information between the plurality of users into text information, while communication is being performed, based on the storage type of the log information being set to the text type. The processor 210 may store the text information.

FIG. 11B illustrates an example of an operation of an electronic device according to an embodiment.

Referring to FIG. 11B, in an embodiment, in a state 1110, a processor 210 may display a log list 1111 stored in memory 230 on a screen 1112. The log list 1111 may include a plurality of objects representing log information. For example, each of the plurality of objects may represent information on a conversation record in one virtual space.

According to an embodiment, the processor 210 may set a type of data to be obtained as the log information. For example, the processor 210 may display an object 1113 for setting the type of the data to be obtained as the log information on the screen 1112. The processor 210 may change a state of an electronic device 200 from the state 1110 to a state 1120 in response to an input on the object 1113.

In the state 1120, the processor 210 may display a screen 1125 in response to the input on the object 1113. The screen 1125 may be displayed to set a type of the data to be obtained as the log information.

According to an embodiment, the processor 210 may display an object 1121 (or a switch) for setting whether to use an automatic storage function of the log information. The processor 210 may set whether to use the automatic storage function of the log information based on an input (e.g., a tap input or a swipe input) on the object 1121. In case of identifying that communication between a plurality of users is terminated, in the virtual space, the processor 210 may determine whether to automatically store the log information.

For example, in case that the automatic storage function of the log information is activated, the processor 210 may display one of an object 1122, an object 1123, and an object 1124 in a selectable state for setting the type of the data to be obtained as the log information. For example, the object 1122 may be displayed to set the type of the data to be obtained as the log information to an image type. For example, the object 1123 may be displayed to set the type of the data to be obtained as the log information to a video type. For example, the object 1124 may be displayed to set the type of the data to be obtained as the log information to a text type.

According to an embodiment, the processor 210 may receive an input (e.g., the tap input) for selecting one of the object 1122, the object 1123, and the object 1124.

For example, the processor 210 may set the type of the data to be obtained as the log information to the image type, based on receiving an input on the object 1122. The processor 210 may obtain a plurality of images and store the plurality of images as the log information, according to the operations illustrated in FIG. 6. The processor 210 may store the plurality of images arranged within a designated frame as the log information.

For example, the processor 210 may set the type of the data to be obtained as the log information to the video type, based on receiving an input on the object 1123. The processor 210 may obtain a plurality of videos according to the operations illustrated in FIG. 8. The processor 210 may store the plurality of videos, and a plurality of images obtained based on the plurality of videos, as the log information.

For example, the processor 210 may set the type of the data to be obtained as the log information to the text type, based on receiving an input on the object 1124. The processor 210 may obtain a plurality of first text messages and a plurality of second text messages according to the operations illustrated in FIG. 10. The processor 210 may store the plurality of first text messages and the plurality of second text messages as the log information.

According to an embodiment, the processor 210 may set the type of the data to be stored as the log information before the communication between the plurality of users is performed in the virtual space. For example, the processor 210 may display a screen (e.g., a screen 1125) to set the type of the data to be stored as the log information, before a user of the electronic device 200 enters the virtual space. The processor 210 may obtain and store the log information according to the set data type while the communication between the plurality of users is performed in the virtual space based on the set data type.

According to an embodiment, the processor 210 may set the type of the data to be stored as the log information while the communication between the plurality of users is performed in the virtual space. The processor 210 may identify an input for changing the type of the data to be stored as the log information while the communication between the plurality of users is performed in the virtual space. The processor 210 may display a screen (e.g., the screen 1125) to change the type of the data to be stored as the log information based on the identified input.

According to an embodiment, the processor 210 may set the type of the data to be stored as the log information after the communication between the plurality of users is performed in the virtual space. The processor 210 may display the screen (e.g., the screen 1125) for setting the type of the data to be stored as the log information based on identifying that the communication between the plurality of users is terminated in the virtual space. The processor 210 may set the type of the data to be stored as the log information in the screen. For example, the processor 210 may store raw data for obtaining data of the image type data, the video type, and the text type in a buffer, while the communication between the plurality of users is performed in the virtual space. The processor 210 may set the type of the data to be stored as the log information based on identifying that the communication between the plurality of users is terminated in the virtual space. The processor 210 may obtain data according to the set data type from the raw data, and store the data in the memory 230.

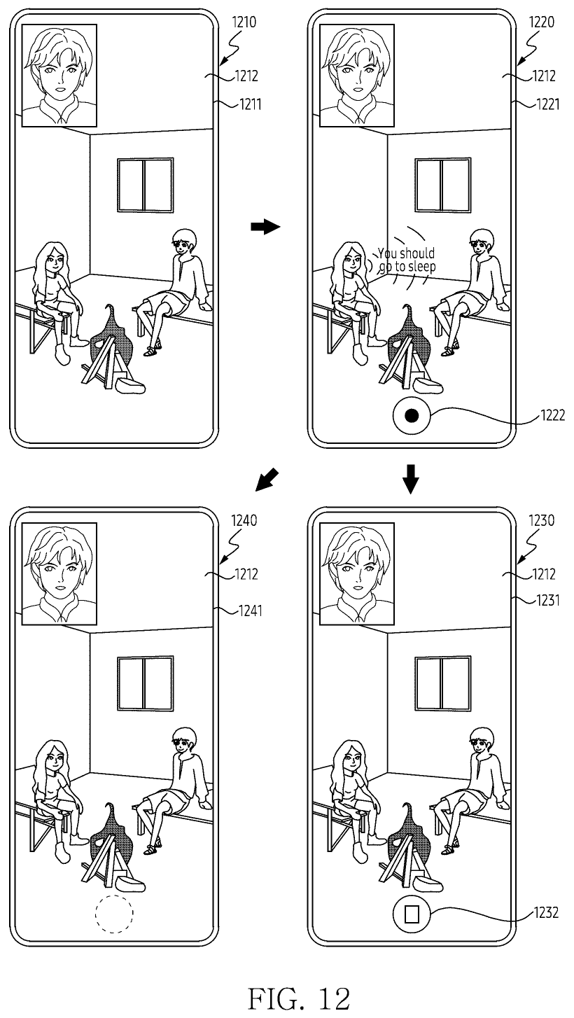

FIG. 12 illustrates an example of an operation of an electronic device according to an embodiment.

Referring to FIG. 12, in a state 1210, a processor 210 may display a virtual space 1212 on a screen 1211. A user of an electronic device 200 may communicate with at least one other user in the virtual space 1212 provided (or displayed) through the screen 1211.

In a state 1220, the processor 210 may identify an utterance of one of a plurality of users including the user of the electronic device 200 and at least one other user. The processor 210 may display an object 1222 for performing recording for a screen 1221 (or the virtual space 1212) on the screen 1221, in response to identifying the utterance. For example, the processor 210 may change a state of the electronic device 200 from the state 1220 to a state 1230, based on identifying an input on the object 1222. For example, in the state 1220, the processor 210 may identify that the input on the object 1222 is not identified, and that the utterance of one of the plurality of users is terminated. In the state 1220, the processor 210 may change the state of the electronic device 200 from the state 1220 to a state 1240, based on identifying that the input on the object 1222 is not identified, and the utterance of one of the plurality of users is terminated.

In an embodiment, in the state 1230, the processor 210 may change the object 1222 to an object 1232, based on identifying the input on the object 1222. While the object 1232 is displayed, a video may be recorded.

According to an embodiment, the processor 210 may start the recording, based on identifying that the utterance of one of the plurality of users starts. The processor 210 may obtain the video from a timing in which the utterance starts to a timing in which the utterance is terminated. In an embodiment, while the recording for the screen (or the virtual space 1212) is being performed, the processor 210 may display the object 1232 representing that the recording is being performed. For example, the processor 210 may start the recording, based on identifying that the utterance of one of the plurality of users starts, without identifying the input on the object 1222.

In the state 1240, the processor 210 may cease displaying the object 1222, in response to identifying that the input on the object 1222 is not identified and that the utterance of one of the plurality of users is terminated. The processor 210 may cease displaying the object 1222 in a screen 1241, based on identifying that conversation does not occurring between the plurality of users. The processor 210 may display the object 1222 again, based on identifying the utterance of one of the plurality of users.

According to an embodiment, each of the screen 1211, the screen 1221, a screen 1231, and the screen 1241 displayed in the state 1210 to the state 1240 may correspond to the screen 300 of FIG. 3.

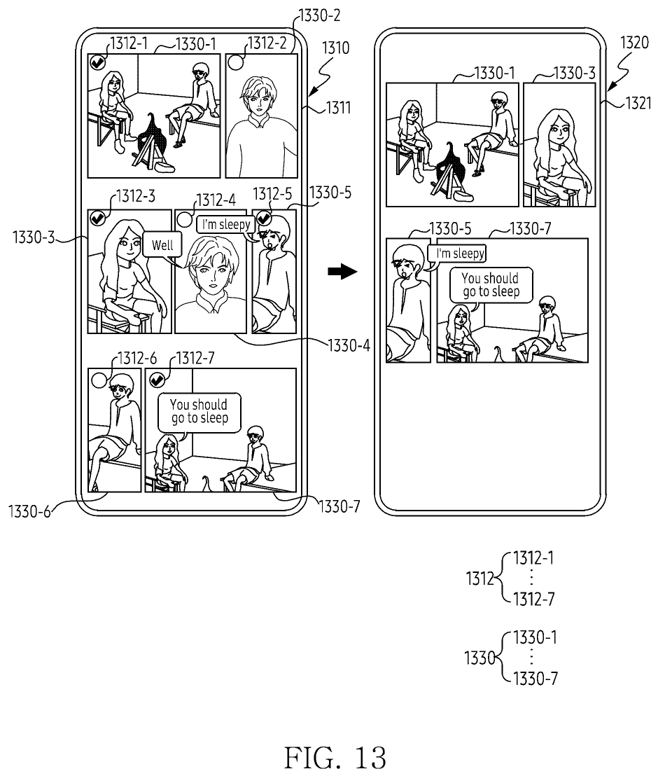

FIG. 13 illustrates an example of an operation of an electronic device according to an embodiment.

Referring to FIG. 13, in a state 1310, a processor 210 may display a plurality of images 1330 obtained while communication between a plurality of users is performed in a virtual space in a screen 1311. The processor 210 may display the screen 1311 including the plurality of images 1330, in response to identifying that the communication between the plurality of users is terminated in the virtual space. The processor 210 may identify an input for selecting at least one image among the plurality of images 1330. For example, the processor 210 may display a plurality of objects 1312 for selecting at least one of the plurality of images 1330, in response to an input (e.g., a long press input) on at least a portion of the screen 1311. Each of the plurality of objects 1312 may correspond to the plurality of images 1330. For example, an object 1312-1 may correspond to a first image 1330-1 among the plurality of images 1330. For example, an object 1312-2 may correspond to a second image 1330-2 among the plurality of images 1330. For example, an object 1312-7 may correspond to a seventh image 1330-7 among the plurality of images 1330.

According to an embodiment, the processor 210 may identify the input for selecting at least one image among the plurality of images 1330. For example, the processor 210 may identify an input for selecting the first image 1330-1, a third image 1330-3, a fifth image 1330-5, and the seventh image 1330-7. The processor 210 may represent that the first image 1330-1, the third image 1330-3, the fifth image 1330-5, and the seventh image 1330-7 are selected by changing shapes of the object 1312-1, an object 1312-3, an object 1312-5, and the object 1312-7 corresponding to the first image 1330-1, the third image 1330-3, the fifth image 1330-5, and the seventh image 1330-7.

According to an embodiment, the processor 210 may change a state of an electronic device 200 from the state 1310 to a state 1320, based on identifying the input for selecting at least one image among the plurality of images 1330. For example, the processor 210 may display a screen 1321 based on identifying the input for selecting at least one of the plurality of images 1330. For example, the processor 210 may arrange the first image 1330-1, the third image 1330-3, the fifth image 1330-5, and the seventh image 1330-7 in a designated frame. For example, the processor 210 may display the first image 1330-1, the third image 1330-3, the fifth image 1330-5, and the seventh image 1330-7 on the screen 1321 in a cartoon format.

According to an embodiment, an electronic device (e.g., the electronic device 200) may comprise a display (e.g., the display 220), communication circuitry (e.g., the communication circuitry 240), memory (e.g., the memory 230), a speaker (e.g., the speaker 270), a microphone (e.g., the microphone 260), and at least one processor (e.g., the processor 210) operably coupled with the display, the communication circuitry, the memory, the speaker, and the microphone. The at least one processor may be configured to, while an application for communication with at least one other user distinct from a user of the electronic device in a virtual space is executed, display the virtual space including a first character (e.g., the character 311) corresponding to the user and at least one second character (e.g., the character 321) corresponding to the at least one other user. The at least one processor may be configured to, while communication between a plurality of users including the user and the at least one other user is performed through the first character and the at least one second character in the virtual space, obtain log information on the communication between the plurality of users. The at least one processor may be configured to, based on identifying that the communication between the plurality of users is terminated in the virtual space, display a plurality of images (e.g., the plurality of images 1330) included in the log information. The at least one processor may be configured to, in response to identifying an input for selecting an image among the plurality of images, display a video corresponding to the selected image, included in the log information.

According to an embodiment, the at least one processor may be configured to obtain a plurality of videos representing the communication while the communication between the plurality of users is performed. The at least one processor may be configured to obtain, based on obtaining a plurality of thumbnails of each of the plurality of videos, the plurality of images. The at least one processor may be configured to obtain the log information including the plurality of videos and the plurality of images.

According to an embodiment, the at least one processor may be configured to obtain utterance data related to the plurality of users while the communication between the plurality of users is performed. The at least one processor may be configured to identify, based on the utterance data, a plurality of utterance intervals satisfying a designated condition. The at least one processor may be configured to obtain the plurality of videos corresponding to the plurality of utterance intervals.

According to an embodiment, the at least one processor may be configured to obtain, based on gesture data related to the first character and the at least one second character and the utterance data related to the plurality of users, a plurality of candidate images. The at least one processor may be configured to obtain, based on filtering the plurality of candidate images, the plurality of images. The at least one processor may be configured to arrange, based on time in which the plurality of images are obtained, the plurality of images in a designated frame. The at least one processor may be configured to store the plurality of images arranged in the designated frame, as the log information.

According to an embodiment, the at least one processor may be configured to, while the plurality of images are displayed, identify an input for selecting, among the plurality of images, at least one image to be arranged in the designated frame. The at least one processor may be configured to arrange, based on the input for selecting the at least one image, the at least one image according to a time sequence in the designated frame. The at least one processor may be configured to store the at least one image arranged in the designated frame, as the log information.

According to an embodiment, the at least one processor may be configured to store, based on identifying that the communication between the plurality of users in the virtual space, is terminated, the log information in the memory. The at least one processor may be configured to display the log information and other log information on other communication distinct from the communication, stored in the memory. The at least one processor may be configured to display, based on an input for displaying the log information, the plurality of images.

According to an embodiment, the at least one processor may be configured to display the first character within a first area among the first area and a second area in a screen displaying the virtual space. The at least one processor may be configured to display the at least one second character within the second area while the first character is displayed within the first area. The at least one processor may be configured to display a plurality of first text messages related to the communication between the plurality of users, superimposed on a portion of the second area.

According to an embodiment, the at least one processor may be configured to obtain the utterance data related to the plurality of users while the communication between the plurality of users is performed. The at least one processor may be configured to obtain, based on setting the utterance data as an input value of a designated model indicated by a plurality of parameters, text data. The at least one processor may be configured to obtain, based on the text data, a plurality of second text messages.

According to an embodiment, the log information may include the plurality of first text messages and the plurality of second text messages.

According to an embodiment, the at least one processor may be configured to, based on identifying that the communication between the plurality of users is terminated, sort the plurality of first text messages and the plurality of second text messages according to the plurality of users. The at least one processor may be configured to, display, the plurality of first text messages and the plurality of second text messages sorted according to the plurality of users, according to a time sequence.

According to an embodiment, the at least one processor may be configured to identify an input for setting a type of data to be stored as the log information. The at least one processor may be configured to set, based on the input, the type of the data to be stored as the log information, to one of a text type, an image type, and a video type.

According to an embodiment, the at least one processor may be configured to display an object for obtaining a video, superimposed in the virtual space while the communication between the plurality of users is performed. The at least one processor may be configured to, in response to an input on the object, obtain a video representing the communication between the plurality of users from a timing in which the input is received.

According to an embodiment, a method of an electronic device (e.g., the electronic device 200) may comprise, while an application for communication with at least one other user distinct from a user of the electronic device in a virtual space is executed, displaying the virtual space including a first character (e.g., the character 311) corresponding to the user and at least one second character (e.g., the character 321 and the character 322) corresponding to the at least one other user. The method may comprise, while communication between a plurality of users including the user and the at least one other user is performed through the first character and the at least one second character in the virtual space, obtaining log information on the communication between the plurality of users. The method may, based on identifying that the communication between the plurality of users is terminated in the virtual space, displaying a plurality of images (e.g., the plurality of images 1330) included in the log information. The method may comprise, in response to identifying an input for selecting an image among the plurality of images, displaying a video corresponding to the selected image, included in the log information.

According to an embodiment, the method may comprise obtaining a plurality of videos representing the communication while the communication between the plurality of users is performed. The method may comprise obtaining, based on obtaining a plurality of thumbnails of each of the plurality of videos, the plurality of images. The method may comprise obtaining the log information including the plurality of videos and the plurality of images.

According to an embodiment, the method may comprise obtaining utterance data related to the plurality of users while the communication between the plurality of user is performed. The method may comprise identifying, based on the utterance data, a plurality of utterance intervals satisfying a designated condition. The method may comprise obtaining the plurality of videos corresponding to the plurality of utterance intervals.

According to an embodiment, the method may comprise obtaining, based on gesture data related to the first character and the at least one second character and the utterance data related to the plurality of users, a plurality of candidate images. The method may comprise obtaining, based on filtering the plurality of candidate images, the plurality of images. The method may comprise arranging, based on time in which the plurality of images are obtained, the plurality of images in a designated frame. The method may comprise storing the plurality of images arranged in the designated frame, as the log information.

According to an embodiment, the method may comprise, while the plurality of images are displayed, identifying an input for selecting, among the plurality of images, at least one image to be arranged in the designated frame. The method may comprise arranging, based on the input for selecting the at least one image, the at least one image according to a time sequence in the designated frame. The method may comprise storing the at least one image arranged in the designated frame, as the log information.

According to an embodiment, the method may comprise storing, based on identifying that the communication between the plurality of users in the virtual space, is terminated, the log information in a memory (e.g., the memory 230). The method may comprise displaying the log information and other log information on other communication distinct from the communication, stored in the memory. The method may comprise displaying, based on an input for displaying the log information, the plurality of images.

According to an embodiment, the method may comprise displaying the first character within a first area among the first area and a second area in a screen displaying the virtual space. The method may comprise displaying the at least one second character within the second area, while the first character is displayed within the first area. The method may comprise displaying a plurality of first text messages related to the communication between the plurality of users, superimposed on a portion of the second area.

According to an embodiment, the method may comprise obtaining the utterance data related to the plurality of users, while the communication between the plurality of users is performed. The method may comprise obtaining, based on setting the utterance data as an input value of a designated model indicated by a plurality of parameters, text data. The method may comprise obtaining, based on the text data, a plurality of second text messages.

According to an embodiment, the log information may include the plurality of first text messages and the plurality of second text messages.

According to an embodiment, the method may comprise, based on identifying that the communication between the plurality of users is terminated, sorting the plurality of first text messages and the plurality of second text messages according to the plurality of users. The method may comprise displaying, the plurality of first text messages and the plurality of second text messages sorted according to the plurality of users, according to a time sequence.

According to an embodiment, the method may comprise identifying an input for setting a type of data to be stored as the log information. The method may comprise setting, based on the input, the type of the data to be stored as the log information, to one of a text type, an image type, and a video type.

According to an embodiment, the method may comprise displaying an object for obtaining a video, superimposed in the virtual space, while the communication between the plurality of users is performed. The method may comprise, in response to an input on the object, obtaining a video representing the communication between the plurality of users from a timing in which the input is received.

According to an embodiment, an electronic device (e.g., the electronic device 200) that communicates using a character in a virtual space may comprise a display (e.g., the display 220), communication circuitry (e.g., the communication circuitry 240), memory (e.g., the memory 230), a speaker (e.g., the speaker 270), a microphone (e.g., the microphone 260), and at least one processor (e.g., the processor 210) operably coupled with the display, the communication circuitry, the memory, the speaker, and the microphone. The at least one processor 210 may be configured to display a first character (e.g., the character 311) corresponding to a user and at least one second character (e.g., the character 321, and the character 322) corresponding to at least one other user, in the virtual space. The at least one processor may be configured to, while communication is performed between at least one other user including the user and the plurality of users, provide options for setting whether to store log information related to communication between the plurality of users,.

According to an embodiment, the at least one processor may be configured to provide sub-options for setting a type of the log information to at least one of an image type, a video type, and a text type, based on an input for selecting an option for setting the log information to be stored.

According to an embodiment, the at least one processor may be configured to store voice information between the plurality of users and image information related to the first character and the at least one second character, while the communication is performed, based on a storage type of the log information being set to the image type.

According to an embodiment, the at least one processor may be configured to store the voice information between the plurality of users and video information related to the first character and the at least one second character, while the communication is performed, based on the type of the log information being set to the video type.

According to an embodiment, the at least one processor may be configured to convert the voice information between the plurality of users into text information, while the communication is performed, based on the type of the log information being set to the text type. The at least one processor may be configured to store the text information.

According to an embodiment, the at least one processor may be configured not to store the log information, based on an input for selecting an option for setting not to store the log information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™M), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a display;
communication circuitry;
memory storing instructions;
a speaker;
a microphone; and
at least one processor including processing circuitry,
wherein the instructions, when executed by the at least one processor individually or collectively, cause the electronic device to:
based on an application for communication between at least one user and a user of the electronic device in a virtual space being executed, display the virtual space comprising a first character corresponding to the user of the electronic device and at least one second character corresponding to the at least one user,
in a state in which communication between a plurality of users including the user of the electronic device and the at least one user is being performed through the first character and the at least one second character in the virtual space, obtain log information about the communication between the plurality of users,
based on identifying a termination of the communication between the plurality of users in the virtual space, display a plurality of images included in the log information, and
based on identifying an input for selecting an image among the plurality of images, display a video included in the log information and corresponding to the selected image.

2. The electronic device of claim 1, wherein the at least one processor is further configured to execute the instructions to:
obtain a plurality of videos representing the communication, in the state in which the communication between the plurality of users is being performed,
obtain, based on obtaining a plurality of thumbnails of each of the plurality of videos, the plurality of images, and
obtain the log information comprising the plurality of videos and the plurality of images.

3. The electronic device of claim 2, wherein the instructions, when executed by the at least one processor individually or collectively, cause the electronic device to:
obtain utterance data of the plurality of users, in the state in which the communication between the plurality of users is being performed,
identify, based on the utterance data, a plurality of utterance intervals satisfying a designated condition, and
obtain a plurality of videos corresponding to the plurality of utterance intervals.

4. The electronic device of claim 3, wherein the instructions, when executed by the at least one processor individually or collectively, cause the electronic device to:
obtain, based on gesture data of the first character and the at least one second character and the utterance data of the plurality of users, a plurality of candidate images,
obtain, based on filtering the plurality of candidate images, the plurality of images,
arrange, based on a time in which the plurality of images are obtained, the plurality of images in a designated frame, and
store the plurality of images arranged in the designated frame as the log information.

5. The electronic device of claim 1, wherein the instructions, when executed by the at least one processor individually or collectively, cause the electronic device to:
in a state in which the plurality of images are displayed, identify an input for selecting, among the plurality of images, at least one image to be arranged in a designated frame,
arrange, based on the input for selecting the at least one image, the at least one image in the designated frame according to a time sequence, and
store the at least one image arranged in the designated frame as the log information.

6. The electronic device of claim 1, wherein the instructions, when executed by the at least one processor individually or collectively, cause the electronic device to:
store, based on identifying the termination of the communication between the plurality of users in the virtual space, the log information in the memory,
display the log information and second log information about a second communication distinct from the communication stored in the memory, and
display, based on an input for displaying the log information, the plurality of images.

7. The electronic device of claim 1, wherein the instructions, when executed by the at least one processor individually or collectively, cause the electronic device to:
display the first character within a first area of a screen displaying the virtual space, among the first area and a second area in the screen,
display the at least one second character within the second area, in a state in which the first character is displayed within the first area, and
display a plurality of first text messages based on the communication between the plurality of users superimposed on a portion of the second area.

8. The electronic device of claim 7, wherein the instructions, when executed by the at least one processor individually or collectively, cause the electronic device to:
obtain utterance data of the plurality of users, in the state in which the communication between the plurality of users is being performed,
obtain, based on setting the utterance data as an input value of a designated model indicated by a plurality of parameters, text data, and
obtain, based on the text data, a plurality of second text messages.

9. The electronic device of claim 8, wherein the log information comprises the plurality of first text messages and the plurality of second text messages.

10. The electronic device of claim 9, wherein the instructions, when executed by the at least one processor individually or collectively, cause the electronic device to:
based on identifying the termination of the communication between the plurality of users, arrange the plurality of first text messages and the plurality of second text messages according to the plurality of users, and
display, the plurality of first text messages and the plurality of second text messages sorted according to the plurality of users, according to a time sequence.

11. The electronic device of claim 6, wherein the instructions, when executed by the at least one processor individually or collectively, cause the electronic device to:
identify an input for setting a type of data to be stored as the log information, and
set, based on the input, the type of the data to be stored as the log information, to one of a text type, an image type, and a video type.

12. The electronic device of claim 1, wherein the instructions, when executed by the at least one processor individually or collectively, cause the electronic device to:
display an object for obtaining a video superimposed in the virtual space, in the state in which the communication between the plurality of users is being performed, and
based on receiving an input on the object, obtain a video representing a communication between the plurality of users for a timing at which the input is received.

13. A method of an electronic device, comprising:
based on an application for communication between at least one user and a user of the electronic device in a virtual space being executed, displaying the virtual space including a first character corresponding to the user of the electronic device and at least one second character corresponding to the at least one user;
in a state in which communication between a plurality of users including the user of the electronic device and the at least one user is being performed through the first character and the at least one second character in the virtual space, obtaining log information on the communication between the plurality of users;
based on identifying a termination of the communication between the plurality of users in the virtual space, displaying a plurality of images included in the log information; and
based on identifying an input for selecting an image among the plurality of images, displaying a video included in the log information and corresponding to the selected image.

14. The method of claim 13, wherein the method comprises:
obtaining a plurality of videos representing the communication, in the state in which the communication between the plurality of users is being performed;
obtaining, based on obtaining a plurality of thumbnails of each of the plurality of videos, the plurality of images; and
obtaining the log information including the plurality of videos and the plurality of images.

15. The method of claim 14, wherein the method comprises:
obtaining utterance data of the plurality of users, in the state in which the communication between the plurality of users is being performed;
identifying, based on the utterance data, a plurality of utterance intervals satisfying a designated condition; and
obtaining a plurality of videos corresponding to the plurality of utterance intervals.

16. The method of claim 15, wherein the method comprises:
obtaining, based on gesture data of the first character and the at least one second character and the utterance data of the plurality of users, a plurality of candidate images,
obtaining, based on filtering the plurality of candidate images, the plurality of images,
arranging, based on a time in which the plurality of images are obtained, the plurality of images in a designated frame, and
storing the plurality of images arranged in the designated frame as the log information.

17. The method of claim 13, wherein the method comprises:
in a state in which the plurality of images are displayed, identifying an input for selecting, among the plurality of images, at least one image to be arranged in a designated frame,
arranging, based on the input for selecting the at least one image, the at least one image in the designated frame according to a time sequence, and
storing the at least one image arranged in the designated frame as the log information.

18. The method of claim 13, wherein the method comprises:
storing, based on identifying the termination of the communication between the plurality of users in the virtual space, the log information in the memory,
displaying the log information and second log information about a second communication distinct from the communication stored in the memory, and
displaying, based on an input for displaying the log information, the plurality of images.

19. The method of claim 13, wherein the method comprises:
displaying the first character within a first area of a screen displaying the virtual space, among the first area and a second area in the screen,
displaying the at least one second character within the second area, in a state in which the first character is displayed within the first area, and
displaying a plurality of first text messages based on the communication between the plurality of users superimposed on a portion of the second area.

20. The method of claim 19, wherein the method comprises:
obtaining utterance data of the plurality of users, in the state in which the communication between the plurality of users is being performed,
obtaining, based on setting the utterance data as an input value of a designated model indicated by a plurality of parameters, text data, and
obtaining, based on the text data, a plurality of second text messages.
